(19) United States
(12) Patent Application Publication
(10) Pub. No.: US 2012/0069136 A1
(43) Pub. Date: Mar. 22, 2012

(54) METHODS AND SYSTEMS OF DISPLAYING ADVERTISEMENT OR OTHER INFORMATION AND CONTENT VIA NON-MOBILE PLATFORMS

(76) Inventor: Earnest SMITH, San Diego, CA (US)

(21) Appl. No.: 13/297,289

(22) Filed: Nov. 16, 2011

Related U.S. Application Data
(63) Continuation-in-part of application No. 11/983,646, filed on Nov. 9, 2007, now Pat. No. 8,063,998.
(60) Provisional application No. 60/857,952, filed on Nov. 10, 2006.

(51) Int. Cl. H04N 5/64; H04N 7/15

(52) U.S. Cl. 348/14.08; 348/836; 348/837; 348/E05.128; 348/E07.083

(57) ABSTRACT

The present invention is directed towards an audio/video based interactive system that includes; a) one or more non-mobile structures including one or more non-mobile surfaces; and b) one or more video displays including one or more receiving means and one or more speakers, the one or more video displays being able to wireless transmission or by way of hardwire transmission receive and display content, the one or more video displays being directly mounted on the one or more non-mobile surfaces outwardly and away from the one or more non-mobile structures for viewing from the outside of the one or more non-mobile structures; and c) at least one call center able to generate and broadcast the content via one or more transmission means to the one or more video displays. The present invention also includes the capability to receive and send live content, including full video conferencing.

### RELATED DOCUMENTS

The present application is a Continuation-in-Part application of U.S. patent application Ser. No. 11/983,646, filed Nov. 9, 2007, entitled “Methods of Systems of Displaying Advertisements or Other Information and Content Via Mobile Platforms,” now U.S. Pat. No. 8,063,998, issued Nov. 22, 2011, and claims benefit of priority thereto; and claims benefit of priority to U.S. Provisional Application Ser. No. 60/857,952, filed Nov. 10, 2006, entitled “Methods of Displaying Advertising or Other Information Via Mobile Platforms;” each of which are incorporated herein by reference in their entirety.

### FIELD OF INVENTION

The present invention relates generally to the field of displaying advertising or other information, and particularly to displaying advertisements or interactive games on a monitor configured to display to the outside of a mobile or non-mobile platform employing a wireless or non-wireless feed for displaying recorded or live content from a remote location or broadcast station (“call center”).

### BACKGROUND OF THE INVENTION

A variety advertising methods are available, for example on television and internet or in various printed publications, or different types of displays such as billboards or other types of displays on buses or buildings.

Many of the available methods of advertising are not as effective as they were once. For example, television is still by far the most effective and dynamic medium and is the most heavily purchased medium for all of the top advertisers. However, the problem with television is fragmentation. Television would have been considered a captive medium in the 1950's, but today, with satellite and cable TV delivery to nearly 80% of all TV homes, and the penetration of VCR, DVD, and remote control, television has become hit or miss medium for advertising at best. Most of these TV households are receiving 50 to 150 different channel viewing choices at one time. Advertising in this cluttered environment is getting lost, becoming less effective, and in some cases not available at all, for example HBO, The Disney Channel, Pay-per-view, etc. Advertising agencies have over used many forms of advertising in order to get peoples attention by using commercials, billboards, magazine ads, and the internet. Now people are bored with all of that and are ready for something new.

While there has been a trend to provide more effective and targeted advertising, further improvements in the effectiveness in getting information to potential consumer are desirable, and the present invention addresses the existing problems and provides related benefits.

### SUMMARY OF THE INVENTION

The methods and systems of the present invention are particularly adaptable as additions in the form of displaying means, such as monitors, that can works in conjunction with any type of motor vehicle including cars, box trucks, boats, ships, yachts, trains, recreational vehicles, motorcycles, tractor trailer trucks, or motor scooters, and for non-motorized structures, or a combination thereof. The methods of the present invention can be combined as an addition to any part of the motor vehicle or non-motorized structure in order to turn the motor vehicle or non-motorized structure into a mobile displaying platform for displaying advertisements or other information. For example, the monitor, preferably a high definition monitor, may be installed inside the vehicle or non-motorized structure or outside the vehicle or non-motorized structure facing away from the vehicle or non-motorized structure to be viewed by viewers on the outside of the vehicle or non-motorized structure. In case of large trucks such as trailer truck or big rigs, the monitor may be installed on one or more areas of the outside of walls of the trailer of the truck. The call center of the present invention may employ one or more monitors, computers, cameras, microphones, and speakers that can deliver/send live content to the vehicle's monitor from a remote location.

The present invention provides to the video gaming and advertising world at large the ability to reach a targeted audience that is a better bet to use their products and/or buy their products or services than those offered with other styles of advertising vehicles or non-motorized structures. The present invention is designed to deliver messages to consumers about brand names. For a mass marketer, keeping its brand name and Images in front of consumers is crucial to its survival.

One aspect of the present invention includes an audio/video based interactive system, including: one or more motor vehicles having a front end, a rear end, and a cabin having a plurality of windows in connection with at least a first side wall and a second side wall; one or more monitors including receiving means and one or more speakers, the one or more monitors being able to wirelessly receive and display live or pre-recorded content, the one or more monitors mounted inside or outside the cabin and facing outwardly from the motor vehicle for viewing from the outside of the one or more motor vehicles; and a call center able to generate and broadcast the live or pre-recorded content via one or more transmission means to the one or more monitors.

Another aspect of the present invention includes two or more of the motor vehicles, the two or more motor vehicles being able to communicate and broadcast the live or pre-recorded content with one another the call center

Another aspect of the present invention includes two or more motor vehicles, wherein one or more of the two or more motor vehicles are able to act as the call center by further having a remote camera including a microphone, the remote camera being able to generate and broadcast live or pre-recorded content via one or more transmission means to the other vehicles of the system.

Another aspect of the present invention includes two or more motor vehicles that are operatively liked together via one of the one or more vehicles that is able to act as the call center, wherein two or more garners are able to play a video games with one another on the monitors.

Yet another aspect of the present invention includes an audio/video based interactive system that includes; a) one or more non-mobile structures including one or more surfaces; and b) one or more video displays including one or more receiving means and one or more speakers, the one or more video displays being able to wireless transmission or by way of hardwire transmission receive and display content, the one or more video displays being directly mounted on the one or more surfaces outwardly and away from the one or more non-mobile structures for viewing from the outside of the one or more non-mobile structures; and c) at least one call center able to generate and broadcast the content via one or more transmission means to the one or more video displays.

### BRIEF DESCRIPTION OF THE DRAWINGS

FIG. 1 shows perspective view of a motor vehicle with a monitor mounted on the outside of its cabin. The monitor can also be provided on a surface of a non-mobile structure, which is not shown.

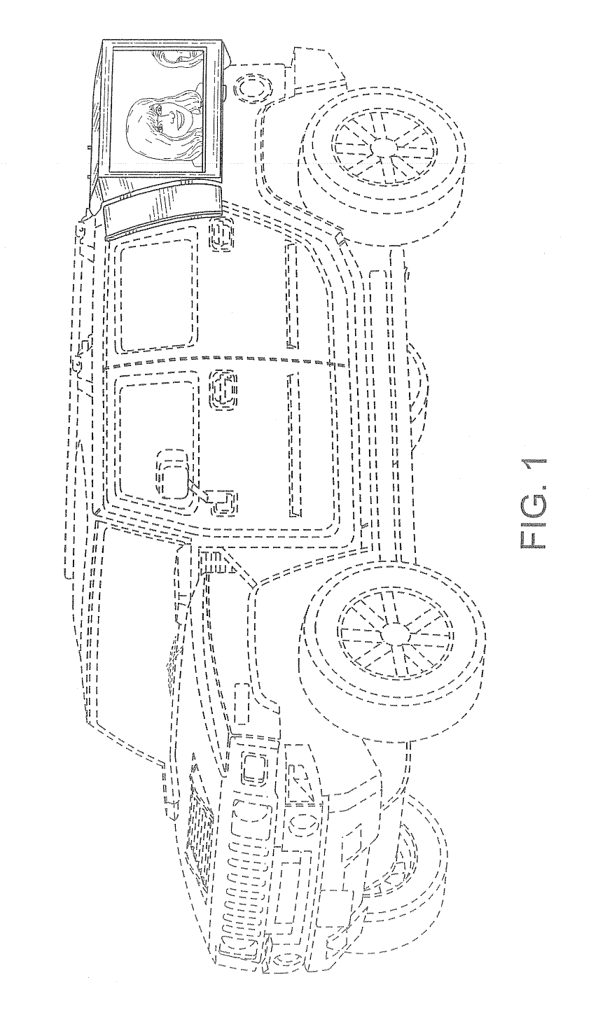

### DETAILED DESCRIPTION OF THE INVENTION

### Introduction

The present invention recognizes that advertising and dissemination of product or service knowledge, and video gaming can be targeted and provided to potential consumers more effectively by providing a new medium and enhanced impressions based on the audio/video based interactive systems of the present invention.

As a non-limiting introduction to the breadth of the present invention, the present invention includes several general and useful aspects, including:
1) An audio/video based interactive system, including:
   a) one or motor vehicles comprising a front end, a rear end, and a cabin comprising a plurality of windows in connection with at least a first side wall and a second side wall;
   b) one or more monitors comprising one or more speakers, the one or more monitors being able to wirelessly receive and display live or pre-recorded content, the one or more monitors mounted inside or outside the cabin and facing outwardly from the one or more motor vehicles for viewing from the outside of the motor vehicle; and
   c) a call center able to generate and broadcast the live or pre-recorded content via one or more transmission means to the one or more monitors.
2) An audio/video based interactive system, including one or more motor vehicles further including a remote camera including a microphone, the remote camera being able to generate and broadcast live or pre-recorded content via one or more transmission means to the call center enabling a complete audio/video conferencing function.
3) An audio/video based interactive system, including two or more motor vehicles, wherein one or more of the two or more motor vehicles are able to act as the call center by further having a remote camera including a microphone, the remote camera being able to generate and broadcast live or pre-recorded content via one or more transmission means to the other vehicles of the system.
4) An audio/video based interactive system, including two or more motor vehicles that are operatively liked together via one of the one or more vehicles that is able to act as the call center, wherein two or more garners are able to play a video games with one another on the monitors.
5) An audio/video based interactive system, including:
   a) one or more non-mobile structures including one or more non-mobile surfaces;
   b) one or more video displays including one or more receiving means and one or more speakers, the one or more video displays being able by way or wireless transmission or by way of hardwire transmission, or a combination of both, receive and display content, the one or more video displays directly mounted on the one or more non-mobile surfaces outwardly and away from the one or more non-mobile structures for viewing from the outside of the one or more non-mobile structures; and
   c) at least one call center able to generate and broadcast the content via one or more transmission means to the one or more video displays.

The present invention can deliver a video advertising impression to consumers in a remote location, as they are purchasing from or shopping in a retail environment and or a mall. The quality of these impressions is greatly enhanced by the medium itself. The newness of the mobile video wall and its place in the retail environment will create a first impression equal to no other impression. It can best be compared to the very first bus billboards, or bus benches, or billboards only more impressive due to its video nature with sight, sound, color, and motion Even further, in many cases this video wall and its messages will entertain most consumers.

Further objectives and advantages of the present invention will become apparent as the description proceeds and when taken in conjunction with the accompanying drawings. To gain a full appreciation of the scope of the present invention, it will be further recognized that various aspects of the present invention can be combined to make desirable embodiments of the invention.

Unless defined otherwise, all technical and scientific terms used herein have the same meaning as commonly understood by one of ordinary skill in the art to which this invention belongs. Where a term is provided in the singular, the inventor also contemplates the plural of that term. The nomenclature used herein and the procedures described below are those well known and commonly employed in the art.

### I. An Audio/Video Based Interactive System

The present invention includes an audio/video based interactive system, including one or more motor vehicles. The motor vehicles of the present invention can be any type of motor vehicle, for example a car, a box truck, a boat, a ship, a yacht, a train, a recreational vehicle, a motorcycle, a tractor trailer truck, or a motor scooter. The motor vehicle of the present invention, much like nearly all types of motor vehicles may have a front end, a rear end, and a cabin. These motor vehicles generally have substantially flat surfaces in some locations of the motor vehicle, and may also have a plurality of windows in connection with one or more of these substantially flat surfaces. The substantially flat surfaces of the motor vehicles of the present invention are generally referred to as sidewalls of the cabin of the motor vehicle, whether or not the motor vehicle, such as for example a motorcycle, includes a traditional cabin. The side walls of the present invention are generally used to mount the monitors of the present invention.

The present invention may include one or more monitors including one or more speakers, wherein the one or more monitors are able to wirelessly receive and display live or pre-recorded content from a remote location. The monitors of the present invention may be any type or brand of monitors that are suitable for the purpose of the present invention. Preferably, the monitors of the present invention have flat screens and include high definition display technology. The monitors may be connected to other devices in connection with the motor vehicle, for example, a power source or power converter, computer, audio/video player/receiver, and/or video game console. Also, the monitor may be operationally connected to other types of devices, for example, a camera or video camera, one or more microphones, one or more signal receivers such as satellite dish and receiver and/or Wi-Fi and/or other internet receivers. All or some of these devices and equipment may be housed inside or outside the vehicle.

An important aspect of the present invention is that one or more monitors mounted inside or outside the cabin and facing outwardly from the motor vehicle for viewing from the outside of the one or more motor vehicles. The monitor may be inside the vehicle and facing outward, for example through a window, or the monitor may be mounted on the outside of the vehicle and facing outward. The monitors may be detachably mounted or fixedly mounted or a combination of both. In addition, the present invention may also include one or more monitors mounted inside of the vehicle for viewing from within the vehicle in addition to the one or more monitors facing outwardly for viewing from the outside of the vehicle.

The present invention also includes a call center able to generate and broadcast the live or pre-recorded content via one or more transmission means to the one or more monitors. The call center of the present invention may be a headquarter, where there are equipment for generating and broadcasting content to the monitors of the present invention, and/or the call center may also receive the content from a different source and then broadcast or transmit the same to the monitors of the present invention. From the call center, the content may be wirelessly broadcasted or transmitted by any suitable transmission means to the remote locations of the one or more vehicles. Transmission means may include any suitable wireless signal transmission means able to perform the purpose of the present invention, for example by means of a computers, the internet, Wi-Fi, and/or satellite or any other suitable broadcasting or transmitting means. The content sent from the call center or a remote location such as a vehicle of the present invention can be received by receiving vehicle of the present invention and displayed on the monitors. The receiving means may include any suitable wireless signal receiving means able to perform the purpose of the present invention, for example by means of a computer, satellite dish receiver and then displayed on the monitor, located on the remote vehicle facing outward such that persons outside the vehicle can watch the monitor. There are no limits to the type of content that can be generated or created and transmitted or broadcast and received and displayed by the monitors of the present invention. Anything and everything that can be generated and displayed on a monitor, for example from news to advertising, from live sporting events to the internet, text messaging, and photo sharing, from instructional programming and interactive product knowledge to video games can be generated and displayed by the present invention. Video games are immensely popular these days, and the present invention will allow players to engage one another from anywhere in the world and play video games for fun and competition. The live or pre-recorded contents can be displayed on the monitors of the present invention while the motor vehicle is moving and viewers on the road or sidewalks can view the displayed content, or the motor vehicle of the present invention may be parked and viewers can view the displayed content from outside the motor vehicle.

The present invention may also include one or more cameras and microphones in connection with the motor vehicle along with the one or more monitors of the motor vehicle, where live or pre-recorded content may be generate and broadcast or transmitted via one or more of the transmission means to the call center enabling a complete audio/video conferencing function. For example, a teleconference can be between a remote location where the motor vehicle of the present invention is located and the call center. The motor vehicle containing the essential devices and components—for transmitting or broadcasting live or pre-recorded content—can act like the call center of the present invention, communicating with other motor vehicles and/or the central call center. For example, two motor vehicles can communicate and transmit and receive content to and from one another and also with the call center. Where there are two or more vehicles containing the essential devices and components—for transmitting or broadcasting live or pre-recorded content—those motor vehicles can each act like the call center of the present invention, communicating with each other and/or the central call center. The central call center of the present invention will not be necessary when one or more of the motor vehicles can act like the call center, where each motor vehicle is capable of providing a mobile call center. Furthermore, the call center can be a mobile call center in a remote location away from the motor vehicles of the present invention, where live or pre-recorded content can be generated and transmitted to the motor vehicles. For example a mobile call center may be creating and broadcasting live content from a restaurant, and the broadcast may be transmitted to remote locations where the motor vehicles of the present invention are located. Or alternatively, the content may be generated or created at a remote location where the motor vehicle of the present invention is located, and then transmitted to the restaurant. It is important to note that there are not limits to the distance or range of broadcasting or transmission and receiving of the content of the present invention. Content may be generated at one specific location and be displayed at any location in the world, or alternatively, content may be generated anywhere in the world, and be displayed in one specific location.

### II. An Audio/Video Based Interactive System Including Non-Mobile Structures

The present invention includes an audio/video based interactive system, including: a) one or more non-mobile structures including one or more non-mobile surfaces; b) one or more video displays including one or more receiving means and one or more speakers, the one or more video displays being able by way of wireless transmission or by way of hardwire transmission, or a combination of both, receive and display content, the one or more video displays directly mounted on the one or more non-mobile surfaces outwardly and away from the one or more non-mobile structures for viewing from the outside of the one or more non-mobile structures; and c) at least one call center able to generate and broadcast the content via one or more transmission means to the one or more video displays.

The description of the invention above describes many of the elements of this aspect of the present invention, which is incorporated herein. The following further describes common elements of this aspect of the present invention with those set forth above, and describes additional elements for this aspect of the present invention as well.

The non-mobile structures of the present invention can be any non-mobile structures applicable in the present invention. For example, non-mobile structures can be a free-standing structure, such as a building, or be part of a larger structure, such as a place of business, such as a business space or office space within a mall, office building or other structure that houses multiple spaces that can be free standing or integrated into a larger structure. In the case of a mall or similar structure, the structure can be within a larger structure, or be with a complex of buildings, such as in malls or centers that have multiple buildings or sections that can be connected or not connected by passageways such as tunnels, covered walkways, or open air walkways. A structure can also be a kiosk or similar structures that are found inside, outside or in close proximity to a structure, such as those commonly found in malls or complexes.

The non-mobile surface can be any surface within or outside of a structure applicable to the present invention. For example, the non-mobile surface can be an outside wall or an inside wall of a structure. A surface can also be part of furniture, such a reception desk in an office, a kiosk, a sales display, or other similar structures.

Non-mobile refers generally to a structure or surface that is not intended to be moved on a routine basis. For example, structures of surfaces that are load bearing or non-load bearing would be non-mobile as they are not intended to be moved except in extreme circumstances, such as in the case of load bearing structures or surfaces, or in the case of non-load bearing structures, would not be moved except during renovations. Non-mobile also refers to the case of the structure or surface not being motorized or otherwise not being capable of being self-propelled.

Video displays refers generally to products that are capable of displaying a video image such as they are known in the art or later developed. Examples include, but are not limited to television sets or monitors, including cathode ray tubes and flat screens, video walls, smart screens, jumbo smart screen and moving screens.

Receiving means include any means that can receive a signal of any sort, such as by a wireless, hardwire or satellite signal, or other signal to be displayed on the video display. Such means include those that are known in the art or later developed and include a wireless receiver, a hardwire receiver, a satellite signal receiver, video codec devices and software, an internet connection, without an internet connection, networks, private networks, public networks, virtual networks, cloud networks, social networks, or a combination thereof.

Transmission means include any means that can transmit a signal of any sort, such as by a wireless, hardwire or satellite signal, or other signal to the receiving means to be displayed on the video display. Such means include those that are known in the art or later developed and include a wireless transmitter, a hardwire transmitter, a satellite signal transmitter, video codec devices and software, an internet connection, without an internet connection, networks, private networks, public networks, virtual networks, cloud networks, social networks, or a combination thereof.

The audio/video based interactive system of the present invention can include structures or surfaces that are essentially non-mobile. Essentially non-mobile refers to the case where the structure or surface is not intended to be mobile in it's normal course of use, such as in the case of load-bearing structures or surfaces, or non-load bearing structures or surfaces that are intended to stay in place for potentially an extended period of time.

The audio/video based interactive system of the present invention can include structures or surfaces that are temporary. In this instance, temporary structures or surfaces refers to the case where the structure or surface, while non-mobile in use, can be mobilized with relative ease when that is desirable. For example, temporary structures or surfaces can include, but are not limited to room dividers, cubicle dividers, accordion type room dividers, full walls, or partial walls.

The audio/video based interactive system of the present invention includes the case where the non-mobile structure or surface has a commercial purpose or a non-commercial purpose, as those terms are known in the art. Examples include, but are not limited to a mall, a retail mall, a store, a retail store, a restaurant, a billboard, or a combination thereof. Other examples include, but are not limited to, a convention center, a hotel, a motel, a resort, an arena, a stadium, an auto dealership, a place of worship, a church, a synagogue, a mosque, or a combination thereof. Further examples include, but are not limited to an amusement park, an entertainment center, a movie theatre, an office building, an educational center, a museum or a combination thereof.

The audio/video based interactive system of the present invention can include the instance wherein the surface is inside or outside of the structures. As a non-limiting example, in the case of a hotel, the surface can be on the outside wall of a hotel facing the outside environment, or can be inside of a hotel, such as in a reception area, meeting room, gaming area, or other inside spaces of the hotel, preferably, but not limited to the case where people can or may gather.

The audio/video based interactive system of the present invention includes, but is not limited to the instance where the video display is detachably mounted outwardly and away on the non-mobile structure or non-mobile surface. In the alternative, the video display is fixedly mounted outwardly and away on the non-mobile structure or non-mobile surface. In addition, the video display can include, but is not limited to, a monitor, a screen, a video wall, a moving screen, or a combination thereof. Furthermore, the video display can be interactive or non-interactive with a person or a group of people.

The audio/video based interactive system of the present invention includes, but is not limited to, the instance where the content includes interactive or non-interactive advertising or product knowledge, or a combination thereof. Furthermore, the content can be live or pre-recorded, or a combination thereof.

In addition, the audio/video based interactive system of the present invention includes an interactive interface to collect data and information from one or more viewers. In this aspect of the invention, viewers can “vote” for a product, such as does the viewer prefer product A or product B, or indicate their usage of a product or services, such as in Nielsen ratings for television programs, as an example. The data and information gathered from such polling can be compiled and provided or sold to vendors. This system can also be used for other polling applications, such as, but not limited to, exit polling from elections, community feedback to government or elected officials, or feedback from customers or other viewers. The system of the present invention can also gather demographic information of viewers, either by direct entry of information, or by interface with a “smart phone” such as an i-phone or similar electronic devices. The interface can include smart screen displays, but other displays are applicable to the present invention. Smart screens or jumbo smart screens can be utilized, which can also employ one or more motion sensors to allow a system of the present invention to interact with a passerby or audience member that is in close proximity to a system of the present invention or in close proximity to a particular location. Facial recognition or retinal scan technology, or other technologies used to identify an individual can be utilized to enter and store a user's identity. In one aspect of the present invention, a room or phone booth type kiosk can be utilized to allow video conferencing with other users of the system of the present invention. Audiences, even large ones, can utilize this technology to interact with others, such as celebrities, commentators or televised programs, such as news programs such as Good Morning America or Good Day LA, which have interactions with a local audience, but not with remote audiences. The present invention also includes the capability to receive and send live content, including full video conferencing.

In one aspect of the present invention, the non-mobile structure or non-mobile surface can include at least one remote camera optionally including at least one microphone. The remote camera being able to generate and broadcast content by way of one or more transmission means to one or more call centers, optionally enabling a complete audio/video conferencing function.

In another aspect of the present invention, the audio/video based interactive system of the present invention includes two or more non-mobile structures or non-mobile surfaces which are able to communicate and broadcast content with one another and at least one call center.

In the another aspect of the present invention, the audio/video based interactive system of the present invention includes two or more non-mobile structures or non-mobile structures, where one or more of the non-mobile structures are able to act as the call center by further including at least one remote camera including at least one microphone. The remote camera being able to generate and broadcast content via one or more transmission means to the other non-mobile structure or non-mobile surface of the audio/video based interactive system of the present invention.

In yet another aspect of the present invention, the audio/video based interactive system of the present invention includes two or more non-mobile structures or non-mobile surfaces that are operatively linked together by way of one of the one or more non-mobile structures that is able to act as one or more call centers, wherein two or more gainers are able to play a video games with one another on the one or more video displays.

In a further aspect of the present invention, the audio/video based interactive system of the present invention includes the case where the audio/video based interactive system includes two or more non-mobile structures or non-mobile surfaces that are operatively linked together by way of at least one call center, so that two or more garners are able to play a video games with one another on one or more video displays.

In another aspect of the present invention, the audio/video based interactive system of the present invention includes the case where at least one of the one or more non-mobile structures is non-motorized. In the alternative, the audio/video based interactive system of the present invention includes at least one motorized structure, which is optionally one or more motor vehicles.

All headings are for the convenience of the reader and should not be used to limit the meaning of the text that follows the heading, unless so specified. Various changes and departures may be made to the present invention without departing from the spirit and scope thereof. Accordingly, it is not intended that the invention be limited to that specifically described in the specification or as illustrated in the drawings, but only as set forth in the claims.

What is claimed is:

1. An audio/video based interactive system, comprising:
a) one or more non-mobile structures comprising one or more non-mobile surfaces;
b) one or more video displays comprising one or more receiving means and one or more speakers, said one or more video displays being able by way of wireless transmission or by way of hardwire transmission, or a combination of both, receive and display content, said one or more video displays directly mounted on said one or more non-mobile surfaces outwardly and away from said one or more non-mobile structures for viewing from the outside of said one or more non-mobile structures; and
c) at least one call center able to generate and broadcast said content via one or more transmission means to said one or more video displays.

2. The audio/video based interactive system of claim 1, wherein one or more of said one or more non-mobile structures or said one or more non-mobile surfaces is essentially non-mobile.

3. The audio/video based interactive system of claim 1, wherein one or more of said one or more non-mobile structures or said one or more non-mobile surfaces comprises one or more temporary structures.

4. The audio/video based interactive system of claim 3, wherein said one or more temporary structures comprises a room divider, a cubicle divider, an accordion type room divider, a full wall, or a partial wall.

5. The audio/video based interactive system of claim 1, wherein said one or more one non-mobile structures has a commercial purpose or a non-commercial purpose.

6. The audio/video based interactive system of claim 1, wherein said one or more non-mobile structures is within or comprises a mall, a retail mall, a store, a retail store, a restaurant, a billboard, or a combination thereof.

7. The audio/video based interactive system of claim 1, wherein said one or more non-mobile structures is within or comprises a convention center, a hotel, a motel, a resort, an arena, a stadium, an auto dealership, a place of worship, a church, a synagogue, a mosque, or a combination thereof.

8. The audio/video based interactive system of claim 1, wherein said one or more non-mobile structures is within or comprises an amusement park, an entertainment center, a movie theatre, an office building, an educational center, a museum or a combination thereof.

9. The audio/video based interactive system of claim 1, wherein said one or more surfaces is inside or outside of said one or more non-mobile structures.

10. The audio/video based interactive system of claim 1, wherein said one or more video displays are detachably mounted outwardly and away on said one or more non-mobile structures.

11. The audio/video based interactive system of claim 1, wherein said one or more video displays are fixedly mounted outwardly and away on said one or more non-mobile structures.

12. The audio/video based interactive system of claim 1, wherein said one or more video display comprises at least one monitor, at least one screen, at least one video wall, at least one moving screen, at least one smart screen, at lest one jumbo smart screen or a combination thereof.

13. The audio/video based interactive system of claim 1, wherein said one or more video display is interactive or non-interactive.

14. The audio/video based interactive system of claim 1, further comprising an interface to collect data or information from one or more viewers.

15. The audio/video based interactive system of claim 1, further comprising motion sensors, facial recognition hardware, facial recognition software, eye retina scanning hardware, eye retina scanning software, sensors for smart screens, or a combination thereof.

16. The audio/video based interactive system of claim 1, wherein said content comprises advertising.

17. The audio/video based interactive system of claim 1, wherein said content comprises interactive product knowledge content.

18. The audio/video based interactive system of claim 1, wherein said content is live or pre-recorded.

19. The audio/video based interactive system of claim 1, wherein said content is pre-recorded.

20. The audio/video based interactive system of claim 1, wherein said one or more non-mobile structures further comprise at least one remote camera comprising at lest one microphone, said at least one remote camera being able to generate and broadcast content via one or more transmission means to said one or more call center enabling a complete or partial audio/video conferencing function.

21. The audio/video based interactive system of claim 1, comprising two or more of non-mobile structures, said two or more non-mobile structures being able to communicate and broadcast said content with one another and said at least one call center.

22. The audio/video based interactive system of claim 1, comprising two or more non-mobile structures, wherein one or more of said two or more non-mobile structures are able to act as said at least one call center by further comprising at least one remote camera comprising at least one microphone, said at least one remote camera being able to generate and broadcast content via one or more transmission means to the other non-mobile structures of said audio/video based interactive system.

23. The audio/video based interactive system of claim 1, wherein said audio/video based interactive system comprises two or more non-mobile structures that are operatively linked together via one of said one or more non-mobile structures that is able to act as said one or more call center, wherein two or more garners are able to play a video games with one another on said one or more video displays.

24. The audio/video based interactive system of claim 1, wherein said audio/video based interactive system comprises two or more non-mobile structures that are operatively linked together via said at least one call center, wherein two or more garners are able to play a video games with one another on said one or more video displays.

25. The audio/video based interactive system of claim 1, wherein at least one of said one or more non-mobile structures is non-motorized.

26. The audio/video based interactive system of claim 1, further comprising at least one motorized structure.

27. The audio/video based interactive system of claim 26, wherein said at least one motorized structure comprises at least one motor vehicle.
